(19) United States
(12) Patent Application Publication
(10) Pub. No.: US 2008/0114508 A1
(43) Pub. Date: May 15, 2008

(54) Method for Repairing Vehicle Electronics of a Motor Vehicle

(75) Inventors: Dieter Marx, Leonberg (DE); Hartmut Chodura, Stuttgart (DE); Christian Zurhorst, Stuttgart (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/935,015

(22) Filed: Nov. 5, 2007

(30) Foreign Application Priority Data
Nov. 4, 2006 (DE) DE102006052049.1

(51) Int. Cl. G05D 1/00

(52) U.S. Cl. 701/36; 701/1

(57) ABSTRACT

A method is provided for repairing vehicle electronics containing a plurality of control units on which software and a configuration code describing the configuration of the vehicle electronics in terms of hardware and software is stored. Before a defective control unit is replaced, it is checked whether the configuration of the vehicle electronics changes due to the replacement unit. If the configuration of the vehicle electronics does not change, the defective control unit is replaced. After the defective control unit has been replaced, it is checked whether the new control unit has to be programmed. If the new control unit does not have to be programmed, the actual state is read out from all the control units and it is checked whether the actual state corresponds to the configuration code of the vehicle electronics. If the actual state corresponds to the configuration code, the repair is ended.

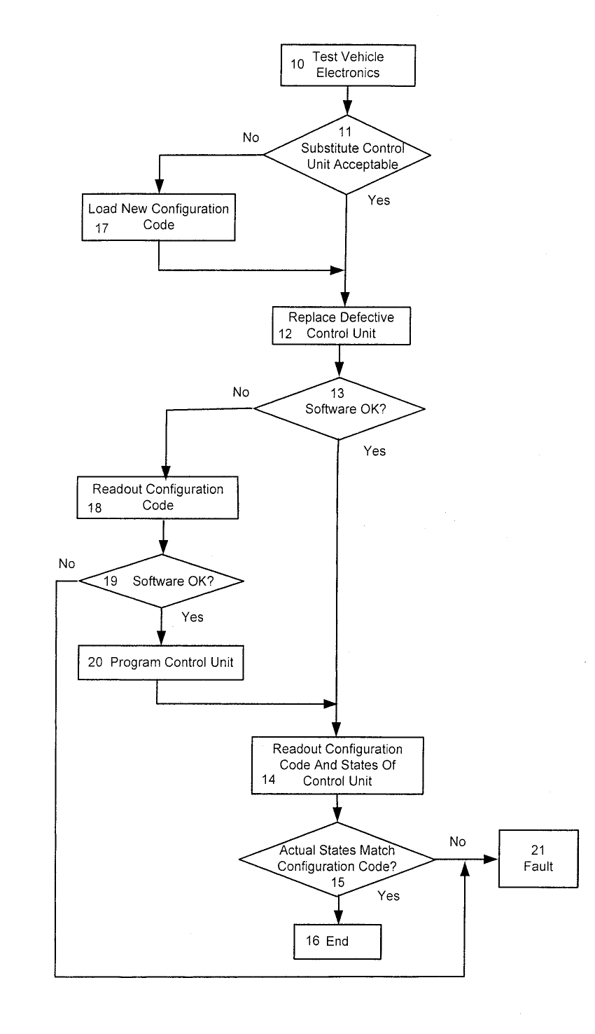

### CROSS-REFERENCE TO RELATED APPLICATION

This application claims the priority, under 35 U.S.C. § 119, of German application DE 10 2006 052 049.1-51, filed Nov. 4, 2006; the prior application is herewith incorporated by reference in its entirety.

### BACKGROUND OF THE INVENTION

### Field of the Invention

The invention relates to a method for repairing vehicle electronics of a motor vehicle. The vehicle electronics include a plurality of control units on which software is stored and, in addition to the software, a configuration code of the vehicle electronics which describes the configuration of the vehicle electronics in terms of hardware and software can also be stored on at least one of the control units.

The vehicle electronics of a motor vehicle contain a plurality of control units, specifically a main control unit and a plurality of additional control units. The main control unit of the vehicle electronics is also referred to as a gateway control unit. Software is stored on the control units of the vehicle electronics. In addition to software, a configuration code of the vehicle electronics which describes the configuration of the vehicle electronics in terms of hardware and software is also stored on a subset of the control units of the vehicle electronics. The configuration code also contains an identification number of the motor vehicle in addition to elements which describe the configuration in terms of hardware and software. The elements of the configuration code which describe the configuration in terms of hardware and software are, in particular, software identifiers, hardware identifiers, data identifiers, parameter set identifiers and code identifiers. The identification number of a motor vehicle is a motor-vehicle-specific number which is valid exclusively for a motor vehicle.

As already mentioned the configuration of vehicle electronics is determined on the one hand by the hardware of the installed control units and on the other hand by the software which is stored on the control units. During the repair of vehicle electronics it is significant that when a defective control unit is replaced by a new control unit the repair leads to a configuration of the vehicle electronics which is released by the motor vehicle manufacturer both in terms of hardware and software. Non-released configurations can, under certain circumstances, lead to malfunctions in the motor vehicle which adversely affect in particular the driving safety of the motor vehicle.

The prior art has hitherto disclosed no methods with which it is possible to ensure in an automated fashion that after the repair of the vehicle electronics of a motor vehicle, a configuration of the vehicle electronics is present which is released by the manufacturer both in terms of hardware and software.

### BRIEF SUMMARY OF THE INVENTION

It is accordingly an object of the invention to provide a method for repairing the vehicle electronics of a motor vehicle which overcomes the above-mentioned disadvantages of the prior art methods of this general type.

With the foregoing and other objects in view there is provided, in accordance with the invention, a method for repairing vehicle electronics of a motor vehicle. The vehicle electronics contain a plurality of control units storing software. A configuration code of the vehicle electronics describing a configuration of the vehicle electronics in terms of hardware and software is stored in at least one of the control units. The control units include a main control unit and at least two additional control units. Before replacing at least one defective control unit with a new control unit, it is checked if the configuration of the vehicle electronics changes due to a replacement of the defective control unit with the new control unit. If, during the checking as to whether the configuration of the vehicle electronics changes due to the replacement of the defective control unit, it is determined that the configuration of the vehicle electronics does not change, the defective control unit in terms of hardware is replaced with the new control unit. After the defective control unit has been replaced in terms of hardware by the new control unit, it is checked whether the new control unit has to be programmed in terms of software. If it is determined that the new control unit does not have to be programmed in terms of the software, an actual state from all of the control units is read out and it is checked whether the actual state corresponds to the configuration code of the vehicle electronics. If, during the checking as to whether the actual state of the control units corresponds to the configuration code of the vehicle electronics, it is determined that the actual state corresponds to the configuration code, the repair is ended.

The present invention proposes for the first time a method which can be used during the repair of the vehicle electronics of a motor vehicle to ensure in an automated fashion that after the repair the configuration of the vehicle electronics is present which is released both in terms of hardware and software.

In accordance with an added mode of the invention, if, during the checking as to whether the configuration of the vehicle electronics changes due to the replacement of the defective control unit, it is determined that the configuration of the vehicle electronics changes, before the defective control unit is replaced in terms of hardware, the configuration code which newly results from the new control unit is loaded into the vehicle electronics and stored therein.

In accordance with an additional mode of the invention, if it is determined that after the defective control unit has been replaced in terms of hardware by the new control unit, that the new control unit has to be programmed in terms of software, the configuration code is read out of the vehicle electronics and it is checked using the configuration code whether the configuration of the vehicle electronics changes as a result of the programming. If the configuration does not change the new control unit is programmed, and if the configuration changes a fault message is output.

In accordance with a further mode of the invention, whenever the configuration code is read out from the vehicle electronics, the configuration code is read out from the main control unit and from each of the additional control units and a comparison is subsequently made as to whether the configuration code stored in the main control unit corresponds to the configuration codes stored in the additional control units. The repair of the vehicle electronics is continued if a correspondence is determined here.

In accordance with another mode of the invention, if it is determined that the configuration code stored in the main control unit differs from the configuration code stored in at least one of the additional control units it is checked whether more than two different configuration codes are present. If more than two different configuration codes are present, a fault message is output, and if not more than two different configuration codes are present, the configuration code which is present in a majority is used and the repair of the vehicle electronics is continued.

In accordance with another further mode of the invention, if during the checking as to whether the actual state of the control units corresponds to the configuration code of the vehicle electronics it is determined that the actual state does not corresponding to the configuration code, a fault message is output.

In accordance with a concomitant mode of the invention, the repair is ended by logging the repair.

Other features which are considered as characteristic for the invention are set forth in the appended claims.

Although the invention is illustrated and described herein as embodied in a method for repairing the vehicle electronics of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a signal flowchart for illustrating a method according to the invention for repairing vehicle electronics of a motor vehicle.

### DETAILED DESCRIPTION OF THE INVENTION

The invention relates to a method for repairing vehicle electronics of a motor vehicle. The vehicle electronics of the motor vehicle includes a plurality of control units on which software is stored. In addition to the software, a configuration code of the vehicle electronics which describes the configuration of the vehicle electronics in terms of hardware and software is also stored on a subset of the control units of the vehicle electronics, preferably on a main control unit and at least two additional control units. With the method according to the invention, it is possible to ensure in an automated fashion that during the repair of the vehicle electronics during which a defective control unit is replaced by a new control unit, after the repair a permitted configuration of the vehicle electronics which is released by the manufacturer is again present both in terms of software and hardware.

Referring now to the single figure of the drawing in detail, in the method according to the invention, a motor vehicle is made available with vehicle electronics which are to be repaired, that is to say with a defective control unit. In step 10 of the method according to the invention a diagnostic device, which is also referred to as a tester, is used to determine in an automated fashion which new control unit is to be substituted in terms of hardware for a defective control unit which is to be replaced. Then, in a step 11, it is checked in an automated fashion whether the configuration of the vehicle electronics changes due to the replacement of the defective control unit by the new control unit. If it is determined in step 11 that the configuration of the vehicle electronics does not change in terms of hardware due to the replacement of a defective control unit, the system branches from step 11 to step 12 and the defective control unit is replaced in terms of hardware by the new control unit.

After the replacement of the defective control unit in terms of hardware by the new control unit in the sense of step 12, it is then checked in an automated fashion in the sense of a step 13 whether the new control unit is already configured in terms of software or whether the control unit has to be programmed. If it is determined during the checking in step 13 that the new control unit is already programmed in terms of software and accordingly does not need to be programmed, the system branches from step 13 to step 14, in which case, in step 14 the diagnostic device is used to read out both the configuration code and the actual states of all the control units from the vehicle electronics of the motor vehicle in an automated fashion.

After the above reading-out of the configuration code and of the actual state of all the control units of the vehicle electronics, it is then checked in an automated fashion in a step 15 whether the actual states correspond to the configuration code of the vehicle electronics. If it is determined here that the actual states correspond to the configuration code, the system branches from step 15 to step 16 and the repair of the vehicle electronics is ended, with the repair which has been carried out being logged in an automated fashion.

If it is determined in step 11 that due to the replacement of a defective control unit in terms of hardware by a new control unit the configuration of the vehicle electronics changes, the system branches from step 11 to step 17. In step 17, before the defective control unit is replaced in terms of hardware by the new control unit in the sense of step 12, the new configuration code is loaded into the vehicle electronics in an automated fashion and stored in an automated fashion in the control units in which the configuration code is stored. The loading and storage of a new configuration code in the vehicle electronics in the sense of step 17 is ensured by virtue of the fact that before an old configuration code is overwritten, the main control unit checks in an automated fashion whether the new configuration code matches the motor vehicle whose vehicle electronics are to be repaired. For this purpose, the identification number of the old configuration code which is to be overwritten is compared with the vehicle identification number of the new configuration code to be stored, in which case the loading and storage of the new configuration code in the vehicle electronics is permitted only if correspondence is determined in the process.

If, on the other hand, a difference is determined in the vehicle identification number, the repair to the vehicle electronics is aborted in an automated fashion and a fault message is generated.

After successful storage of the new configuration code in the vehicle electronics, the system branches from step 17 to step 12, and with regard to step 12 it is possible to refer to the above statements.

If it is determined in step 13 that after the defective control unit has been replaced in terms of hardware by the new control unit, the new control unit is not configured in terms of software and accordingly has to be programmed, the system branches from step 13 to step 18, with the configuration code being read out from the vehicle electronics in an automated fashion in step 18.

Subsequent to step 18, it is then checked in an automated fashion in a step 19 of the method according to the invention using the configuration code whether the software which is to be loaded onto the new control unit while the new control unit is being programmed fits the software configuration of the vehicle electronics.

If it is determined here that the software which is to be used for programming fits the software configuration of the vehicle electronics, the system branches from step 19 to step 20, wherein in step 20 the new control unit is programmed in an automated fashion by loading the software onto the new control unit and storing it. After the control unit has been programmed, the system then branches from step 20 to step 14.

On the other hand, if it is determined in step 19 that the software which is to be loaded onto the new control unit does not fit the software configuration of the vehicle electronics, the system branches from step 19 to step 21, with a fault message being generated and output in an automated fashion in step 21, and the repair of the vehicle electronics being aborted in an automated fashion.

The system also branches from step 15 to step 21, specifically if it is determined in step 15 that the actual states which are read out from the control units in step 14 do not correspond to the configuration code of the vehicle electronics. In this case also, a fault message is generated and output in an automated fashion and the repair of the vehicle electronics is aborted.

As stated above, when the method according to the invention is carried out it is necessary to read out the configuration code from the vehicle electronics in an automated fashion. As already stated, in this context, the configuration code is preferably stored in a plurality of control units of the vehicle electronics, specifically in the main control unit and in at least two additional control units.

During the method according to the invention, whenever the configuration code is read out from the vehicle electronics in an automated fashion, it is checked in an automated fashion whether the configuration code which is read out from the main control unit corresponds to the configuration codes which are read out from the additional control units. Then, if correspondence is determined between the configuration code of the main control unit and the configuration codes of the additional control units the repair of the vehicle electronics is continued in an automated fashion. Then, if, on the other hand, it is determined that the configuration code stored in the main control unit deviates from at least one configuration code of an additional control unit, it is checked in an automated fashion whether more than two different configuration codes are present.

If it is determined here that there are not more than two different configuration codes present, the configuration code present in the majority is used for further repair of the motor vehicle and the repair of the motor vehicle is continued in an automated fashion. If, on the other hand, it is determined that more than two different configuration codes are stored in the vehicle electronics, that is to say that both the configuration code stored in the main control unit deviates from at least one configuration code stored in an additional control unit and the configuration codes stored in the additional control units differ from one another, a fault message is generated and output again in an automated fashion, and the repair of the vehicle electronics is aborted.

Whenever a fault message is generated in the sense of the method according to the invention and the repair of the vehicle electronics is aborted in an automated fashion, comprehensive checking of all the control units of the vehicle electronics is initiated.

The steps of the method according to the invention described above occur in an automated fashion by virtue of the fact that a diagnostic device which is connected to the vehicle electronics communicates with the control units of the vehicle electronics and exchanges data. This ensures that after the vehicle electronics have been repaired a configuration of the vehicle electronics is present which is authorized and approved by the motor vehicle manufacturer. Furthermore, undesired configuration changes of the vehicle electronics which are caused by manual operating faults are avoided.

1. A method for repairing vehicle electronics of a motor vehicle, the vehicle electronics containing a plurality of control units storing software and a configuration code of the vehicle electronics describing a configuration of the vehicle electronics in terms of hardware and software being stored in at least one of the control units, the control units including a main control unit and at least two additional control units, which comprises the steps of:
before replacing at least one defective control unit with a new control unit, checking if the configuration of the vehicle electronics changes due to a replacement of the defective control unit with the new control unit;
if, during the checking as to whether the configuration of the vehicle electronics changes due to the replacement of the defective control unit, it is determined that the configuration of the vehicle electronics does not change, replacing the defective control unit in terms of hardware with the new control unit;
after the defective control unit has been replaced in terms of hardware by the new control unit, checking whether the new control unit has to be programmed in terms of software, if it is determined that the new control unit does not have to be programmed in terms of the software, reading out an actual state from all of the control units and checking whether the actual state corresponds to the configuration code of the vehicle electronics; and
if, during the checking as to whether the actual state of the control units corresponds to the configuration code of the vehicle electronics, it is determined that the actual state corresponds to the configuration code, ending the repair.

2. The method according to claim 1, wherein if, during the checking as to whether the configuration of the vehicle electronics changes due to the replacement of the defective control unit, it is determined that the configuration of the vehicle electronics changes, before the defective control unit is replaced in terms of hardware, the configuration code which newly results from the new control unit is loaded into the vehicle electronics and stored therein.

3. The method according to claim 1, wherein if it is determined that after the defective control unit has been replaced in terms of hardware by the new control unit, that the new control unit has to be programmed in terms of software, the configuration code is read out of the vehicle electronics and it is checked using the configuration code whether the configuration of the vehicle electronics changes as a result of the programming, if the configuration does not change the new control unit is programmed, and if the configuration changes a fault message is output.

4. The method according to claim 1, wherein that whenever the configuration code is read out from the vehicle electronics, the configuration code is read out from the main control unit and from each of the additional control units and a comparison is subsequently made as to whether the configuration code stored in the main control unit corresponds to the configuration codes stored in the additional control units, the repair of the vehicle electronics is continued if a correspondence is determined here.

5. The method according to claim 4, wherein if it is determined that the configuration code stored in the main control unit differs from the configuration code stored in at least one of the additional control units it is checked whether more than two different configuration codes are present, wherein if more than two different configuration codes are present, a fault message is output, and if not more than two different configuration codes are present, the configuration code which is present in a majority is used and the repair of the vehicle electronics is continued.

6. The method according to claim 1, which further comprises that if during the checking as to whether the actual state of the control units corresponds to the configuration code of the vehicle electronics it is determined that the actual state does not corresponding to the configuration code, outputting a fault message.

7. The method according to claim 1, which further comprises ending the repair by logging the repair.
